(19) United States
(12) Patent Application Publication
(10) Pub. No.: US 2025/0279545 A1
(43) Pub. Date: Sep. 4, 2025

(54) ELECTRIC POWER STORAGE DEVICE

(71) Applicant: TOYOTA JIDOSHA KABUSHIKI KAISHA, Toyota-shi (JP)

(72) Inventors: Kazuki SUGIE, Miyoshi-shi (JP); Akio MORI, Toyota-shi (JP); Yoshiro KAMO, Kanagawa-ken (JP); Takahiko NAKANO, Nagoya-shi (JP); Toshihiro SHIMONAKA, Toyota-shi (JP); Kenichi KOHASHI, Shizuoka-ken (JP); Yuki SODA, Nagoya-shi (JP)

(73) Assignee: TOYOTA JIDOSHA KABUSHIKI KAISHA, Toyota-shi (JP)

(21) Appl. No.: 19/052,449

(22) Filed: Feb. 13, 2025

(30) Foreign Application Priority Data
Mar. 4, 2024 (JP) 2024-031979

(51) Int. Cl. H01M 50/474; H01M 10/04; H01M 50/103

(52) U.S. Cl. CPC H01M 50/474; H01M 10/0431; H01M 50/103

(57) ABSTRACT

An electric power storage device includes a plurality of electric power storage units and a housing case. The electric power storage units are arranged in an X direction and laminated in the X direction. Lower surfaces of the electric power storage units are bonded to a lower case with an adhesive member. A protruding portion extending in the X direction is formed in an upper case. The protruding portion protrudes toward the lower case and abuts against an upper surface of the electric power storage units. As a result, the electric power storage units receive a load on the adhesive member side (lower case side) and are pressed down.

### CROSS-REFERENCE TO RELATED APPLICATION

This application claims priority to Japanese Patent Application No. 2024-031979 filed on Mar. 4, 2024, incorporated herein by reference in its entirety.

### BACKGROUND

### 1. Technical Field

The disclosure relates to an electric power storage device.

### 2. Description of Related Art

Japanese Unexamined Patent Application Publication No. 2023-46013 (JP 2023-46013 A) discloses a battery pack in which a plurality of battery cells and the bottom of a case are bonded together with a heat transfer member having adhesive property.

### SUMMARY

There is a concern that the adhesion between a battery cell (electric power storage unit) and a case may be released when vibration or the like is applied to a battery pack.

An object of the present disclosure is to provide a structure in which the adhesion between the electric power storage unit and the case is difficult to be released.

An electric power storage device according to the present disclosure is an electric power storage device that includes a plurality of electric power storage units, and a housing case including a first case and a second case and housing the electric power storage units in a space defined by the first case and the second case. The electric power storage units are bonded to the first case, the second case has a protruding portion protruding toward the first case, and the protruding portion abuts against the electric power storage units.

According to this configuration, the electric power storage units are bonded to the first case. The protruding portion of the second case protrudes toward the first case and abuts against the power storage units. The electric power storage units are pressed toward the first case by the protruding portion of the second case, so that it is possible to restrain the adhesion between the electric power storage units and the housing case from being released.

Preferably, the electric power storage units may be arranged in a lamination direction in the storage case, and the protruding portion may extend in the lamination direction.

According to this configuration, the electric power storage units can be pressed against the first case side by the protruding portion of the second case.

Each of the electric power storage units may have a rectangular parallelepiped shape, and may be bonded to the first case at center portions in a longitudinal direction of the electric power storage units, and the protruding portion may abut against the electric power storage units at the center portions in the longitudinal direction of the electric power storage units.

According to this configuration, the center portion of the electric power storage unit can be bonded to the housing case. Each of the electric power storage units may include a cell assembly in which a plurality of electric power storage cells arranged in a connection direction is electrically connected at connection portions, a cell case that houses the cell assembly, and a reinforcing member that is disposed at the connection portion and reinforces the cell case. In this case, the protruding portion of the second case may abut against the cell case at a position where the reinforcing member is disposed.

According to this configuration, the protruding portion abuts against the cell case at the position where the reinforcing member is arranged, so that it is possible to suitably press the electric power storage units against the first case.

Furthermore, the cell case may be bonded to the first case at the position where the reinforcing member is disposed.

According to this configuration, the cell case is bonded to the first case at the position where the reinforcing member is arranged, so that the force applied to the electric power storage unit by the protruding portion of the second case is suitably transmitted to the bonded location through the reinforcing member.

According to the present disclosure, it is possible to provide a structure in which the adhesion between the electric power storage unit and the case is difficult to be released.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view that schematically shows an electric power storage device according to an embodiment;

FIG. 2 is a diagram that schematically shows an example of an electric power storage unit 10;

FIG. 3A is a sectional view taken along III-III in FIG. 1;

FIG. 3B is a sectional view taken along III-III in FIG. 1;

FIG. 4 is an exploded perspective view of the electric power storage unit according to an embodiment 2;

FIG. 5 is a sectional view of an electric power storage device according to the embodiment 2; and

FIG. 6 is a perspective view that schematically shows an electric power storage device 1B according to a modification.

### DETAILED DESCRIPTION OF EMBODIMENTS

Hereinafter, embodiments of the present disclosure will be described in detail with reference to the drawings. The same or corresponding components in the drawings are designated by the same reference signs, and the description thereof will not be repeated. In the drawings, illustrations are not made according to the actual dimensional ratios, and in order to facilitate understanding of structures, the ratios may be changed such that the structures are clarified. The embodiments and modifications described below may be selectively combined as appropriate.

### Embodiment 1

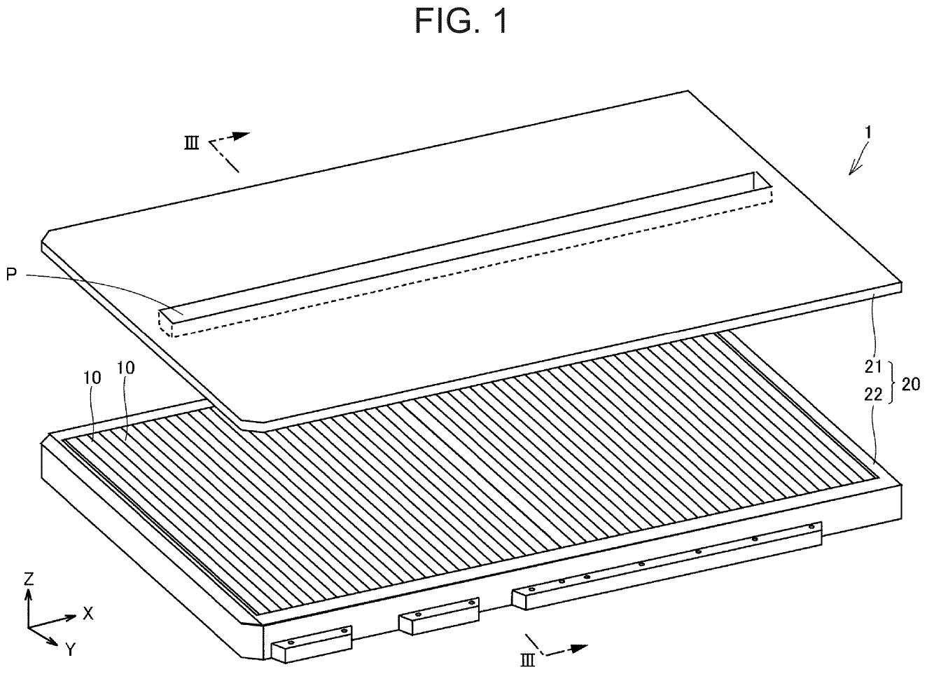

An electric power storage device according to the present embodiment will be described with reference to FIG. 1 to FIG. 3B. FIG. 1 is a perspective view that schematically shows the electric power storage device according to the present embodiment.

With reference to FIG. 1, the electric power storage device 1 is used, for example, while it is mounted on a vehicle. Examples of the vehicle include a hybrid electric vehicle, a plug-in hybrid electric vehicle, a fuel cell electric vehicle, and a battery electric vehicle. The electric power storage device 1 includes a plurality of electric power storage units 10 and a housing case 20 that houses the electric power storage units 10.

The electric power storage unit 10 is a secondary battery, typically a lithium ion battery. The lithium ion battery is a battery that uses lithium as a charge carrier, and it may include not only a general lithium ion secondary battery in which an electrolyte is liquid, but also a so-called all-solid-state battery in which a solid electrolyte is used. Examples of lithium ion batteries include an LFP battery in which lithium iron phosphate is used as a positive electrode active material, and a ternary battery in which nickel manganese cobalt (NMC) is used as a positive electrode active material. Note that the electric power storage unit 10 is not limited to a lithium ion secondary battery, and it may be composed of a nickel-metal hydride secondary battery or other secondary batteries.

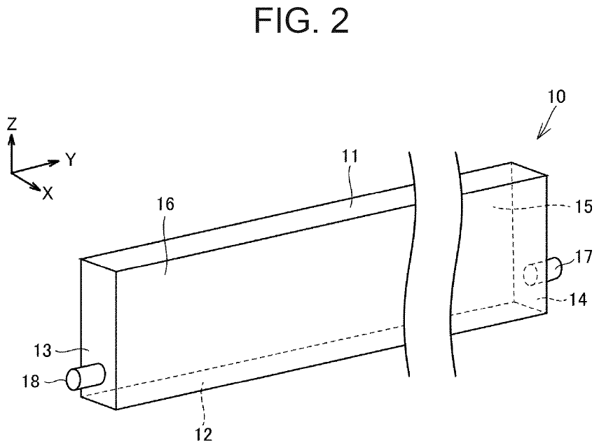

FIG. 2 is a diagram that schematically shows an example of the electric power storage unit 10. In the present embodiment, the electric power storage unit 10 is a lamination type lithium ion battery in which a plurality of battery cells is laminated in a cell case, each of the battery cells being formed by laminating a positive electrode sheet (current collector) coated with a positive electrode active material and a negative electrode sheet (current collector) coated with a negative electrode active material with a separator interposed therebetween. Note that the electric power storage unit 10 may be a bipolar lithium ion battery in which a positive electrode active material is coated on one side of a current collector while a negative electrode active material is coated on the other side of the current collector, and these current collectors are laminated with a separator interposed therebetween.

Referring to FIG. 2, the electric power storage unit 10 has a rectangular parallelepiped shape, and includes an upper surface 11, a lower surface 12, a pair of short side surfaces 13, 14, and a pair of long side surfaces 15, 16 with the long side (longest side) extending in a Y direction. The electric power storage unit 10 further includes a positive electrode terminal 17 and a negative electrode terminal 18. The positive electrode terminal 17 is provided on one of the pair of short side surfaces 13, 14, and the negative electrode terminal 18 is provided on the other of the pair of short side surfaces 13, 14. In the example shown in FIG. 2, the positive electrode terminal 17 is provided on the short side surface 14, and the negative electrode terminal 18 is provided on the short side surface 13. Note that both the positive electrode terminal 17 and the negative electrode terminal 18 may be provided on one of the pair of short side surfaces 13, 14.

Referring to FIG. 1, the housing case 20 includes an upper case 21 and a lower case 22. The lower case 22 includes a bottom plate and a peripheral wall. The bottom plate is formed in a flat plate shape. The peripheral wall is formed so as to extend upward from the outer peripheral edge portion of the bottom plate, and is formed in a ring shape. The electric power storage units 10 are housed in a space formed by assembling the upper case 21 to the lower case 22. FIG. 1 shows the electric power storage device 1 in a state where the upper case 21 is detached. The upper case 21 corresponds to an example of a “second case” in the present disclosure, and the lower case 22 corresponds to an example of a “first case” in the present disclosure.

The electric power storage units 10 are arranged and laminated in an X direction in a space defined by the upper case 21 and the lower case 22, whereby the electric power storage units 10 are housed in the housing case 20. In the present embodiment, the X direction corresponds to a “lamination direction” of the present disclosure.

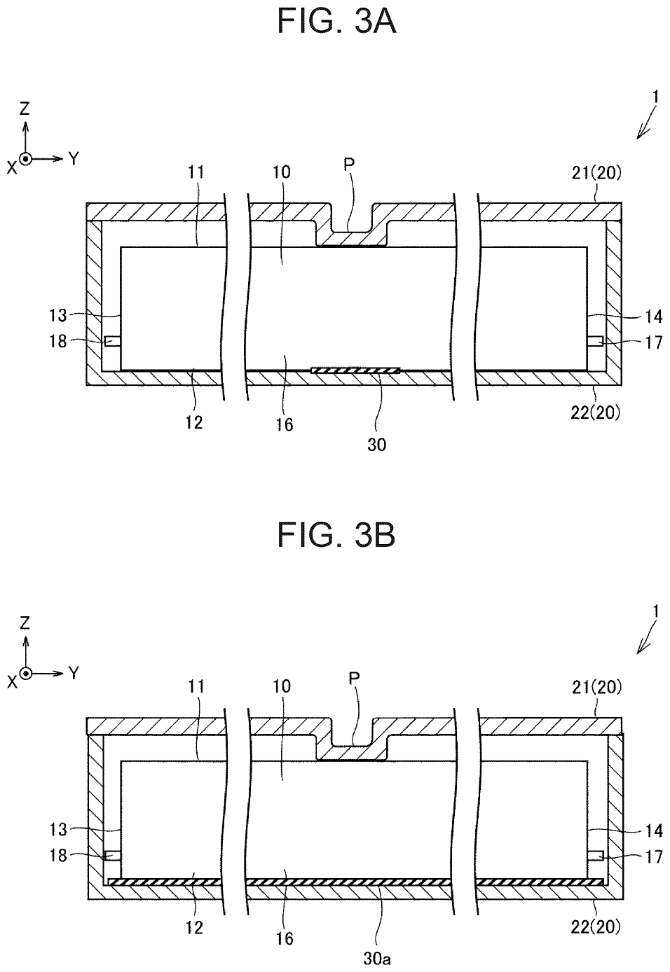

FIG. 3A and FIG. 3B are sectional views taken along III-III in FIG. 1. FIG. 3A shows an example in which a central portion in a longitudinal direction of the electric power storage unit 10 is bonded, and FIG. 3B shows an example in which the entire electric power storage unit 10 is bonded.

Referring to FIG. 3A, the bottom surface 12 of the electric power storage unit 10 and the lower case 22 are bonded to each other with an adhesive member 30 at a substantially central portion in the longitudinal direction of the electric power storage unit 10. A protruding portion P extending in the X direction (lamination direction) is formed in the upper case 21. The protruding portion P protrudes toward the lower case 22. The protruding portion P abuts against the upper surface 11 of the electric power storage unit 10 at a substantially central portion in the longitudinal direction of the electric power storage unit 10. The adhesive member 30 and the protruding portion P are located at positions where they overlap each other in a Z direction.

Referring to FIG. 3B, the lower surface 12 of the electric power storage unit 10 and the lower case 22 are bonded to each other with an adhesive member 30a. The adhesive member 30a bonds substantially the entire lower surface 12 of the electric power storage unit 10 to the lower case 22. A protruding portion P extending in the X direction (lamination direction) is formed in the upper case 21. The protruding portion P protrudes toward the lower case 22. The protruding portion P abuts against the upper surface 11 of the electric power storage unit 10 at a substantially center portion in the longitudinal direction of the electric power storage unit 10.

According to the configuration of FIG. 3A, FIG. 3B, the protruding portion P of the upper case 21 abuts against the upper surface 11 of the electric power storage unit 10, whereby the electric power storage unit 10 receives a load on the adhesive member 30, 30a side (lower case 22 side) and is pressed down. This makes it possible to restrain the adhesion between the electric power storage unit 10 and the housing case 20 (lower case 22) from being released. Furthermore, in the configuration of FIG. 3A, the adhesive member 30 and the protruding portion P are located at positions where they overlap each other in the Z direction, so that even when the central portion in the longitudinal direction of the electric power storage unit 10 is bonded to the lower case 22, it is possible to preferably restrain the adhesion between the electric power storage unit 10 and the housing case 20 (lower case 22) from being released.

In the configuration of FIG. 3A and FIG. 3B, a cooler for cooling the electric power storage unit 10 may be disposed in a space between the upper case 21 and the upper surface 11 of the electric power storage unit 10. In the configuration of FIG. 3A, coolers may be disposed between the bottom surface 12 of the electric power storage unit 10 and the lower case 22 on both sides in the Y direction of the adhesive member 30.

### Embodiment 2

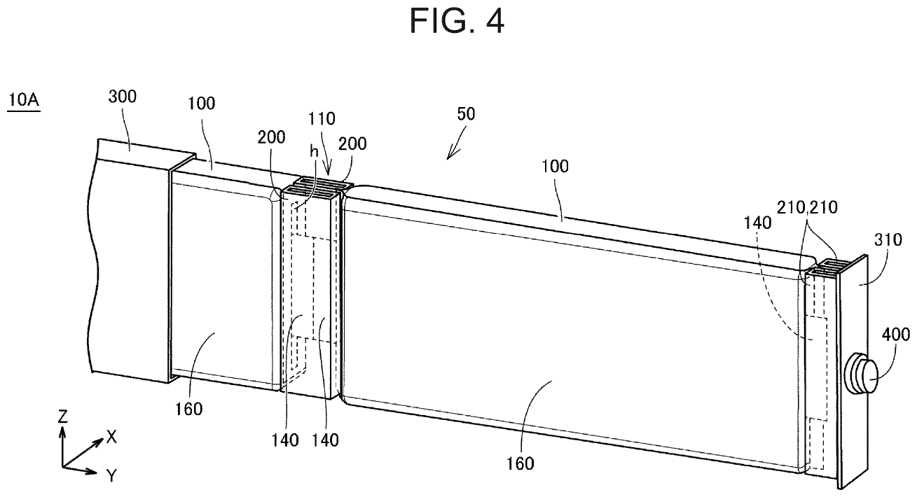

FIG. 4 is an exploded perspective view of an electric power storage unit 10A according to an embodiment 2. In the embodiment 2, the electric power storage unit 10A includes a cell assembly 50 in which a plurality of electric power storage cells 100 is electrically connected at connection portions 110. The electric power storage cell 100 is, for example, a lithium ion battery. The electric power storage cell 100 includes, for example, an electrode body made of a wound body in which a positive electrode sheet coated with a positive electrode active material and a negative electrode sheet coated with a negative electrode active material are wound with a separator interposed therebetween, and a laminate exterior body 160 that seals the electrode body.

The electric power storage cell 100 has current collecting terminals 140 (one is a positive electrode and the other is a negative electrode) at both ends in the Y direction, and the current collecting terminals 140 of adjacent electric power storage cells 100 are electrically connected to each other in series at the connection portions 110 to form the cell assembly 50. The cell assembly 50 is inserted into the cell case 300, and a cover member 310 is joined to the cell case 300, whereby the cell assembly 50 is housed in the cell case 300 to form the electric power storage unit 10A. FIG. 4 is a perspective view of the cell assembly 50 when the cell assembly 50 is inserted into the cell case 300. The electric power storage unit 10A includes the cell assembly 50 in which a plurality of electric power storage cells 100 arranged in the Y direction (connection direction) is electrically connected, and the cell case 300 that houses the cell assembly 50.

A pair of reinforcing members 200 are provided at the connection portion 110 of the cell assembly 50 so as to interpose the current collecting terminals 140 therebetween. The reinforcing member 200 has a rectangular prism shape that is hollow in the Z direction. The material of the reinforcing member 200 may be synthetic resin or metal. The length of the reinforcing member 200 in the Z direction is the same as the width of the inner surface of the cell case 300 in the Z direction. Therefore, the reinforcing member 200 functions as a reinforcing member (so-called support rod) for the cell case 300 at the connection portion 110 of the cell assembly 50.

Output terminals 400 (one is a positive terminal, the other is a negative terminal) are connected to the current collecting terminals 140 on both sides of the cell assembly 50. Furthermore, a pair of reinforcing members 210 similar to the reinforcing members 200 may be provided so as to interpose the current collecting terminals 140 on both sides of the cell assembly 50 therebetween.

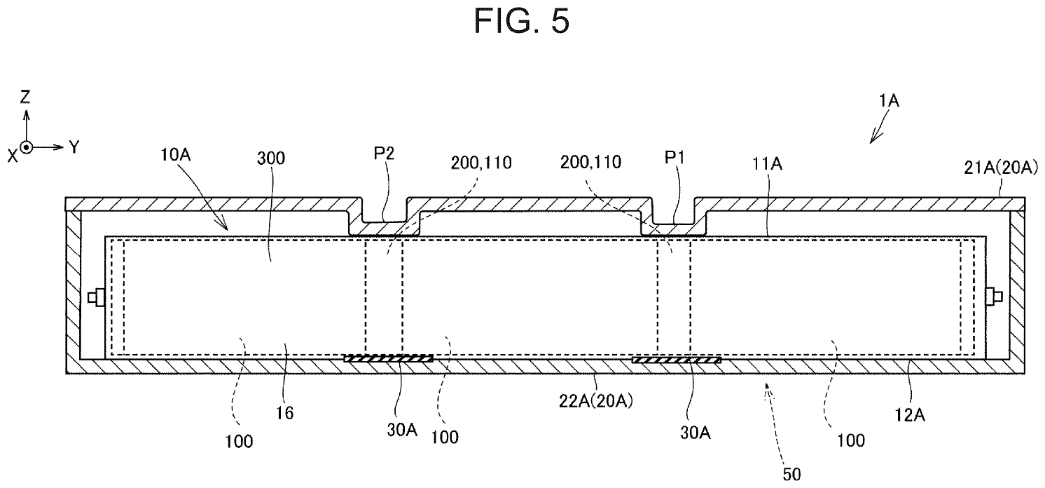

FIG. 5 is a sectional view of the electric power storage device 1A according to the embodiment 2. This sectional view is a sectional view of a portion similar to that of FIG. 3A, FIG. 3B. In the embodiment 2, the cell assembly 50 is formed of three electric power storage cells 100. A housing case 20A includes an upper case 21A and a lower case 22A. The plurality of electric power storage units 10A is arranged in the X direction and laminated in a space defined by the upper case 21A and the lower case 22A, whereby the electric power storage units 10A are housed in the housing case 20A.

The lower surface 12A of the electric power storage unit 10A (cell case 300) and the lower case 22A are bonded to each other with adhesive members 30A, 30A. The adhesive members 30A are provided at positions where the reinforcing members 200 are arranged (the positions of the connection portions 110 of the cell assembly 50), and bond the electric power storage unit 10A and the lower case 22A to each other. Protruding portions P1, P2 extending in the X direction (lamination direction) are formed in the upper case 21. The protruding portions P1, P2 protrude toward the lower case 22A. The protruding portions P1, P2 abut against the upper surface 11A of the electric power storage unit 10A (cell case 300). The adhesive members 30A, 30A and the protruding portions P1, P2 are arranged at positions where they overlap each other in the Z direction.

According to the embodiment 2, the protruding portions P1 and P2 of the upper case 21A abut against the upper surface 11A of the electric power storage unit 10A (cell case 300), whereby the electric power storage unit 10A receives a load and is pressed against the adhesive member 30A (lower case 22A side). This makes it possible to restrain the adhesion between the electric power storage unit 10A and the housing case 20A (lower case 22A) from being released. Furthermore, the protruding portions P1, P2 and the adhesive members 30A, 30A are arranged at positions where they overlap each other in the Z direction at the positions where the reinforcing members 200 are arranged. As a result, the force applied to the electric power storage unit 10A (cell case 300) by the protruding portions P1, P2 is efficiently transmitted to the adhesive members 30A, 30A (adhesive points) through the reinforcing members 200, so that it is possible to more preferably restrain the adhesion between the electric power storage unit 10A and the housing case 20A (lower case 22A) from being released.

In the embodiment 2, the cell assembly 50 is configured by three electric power storage cells 100. However, the number of electric power storage cells 100 may be two, or four or more.

### Modification

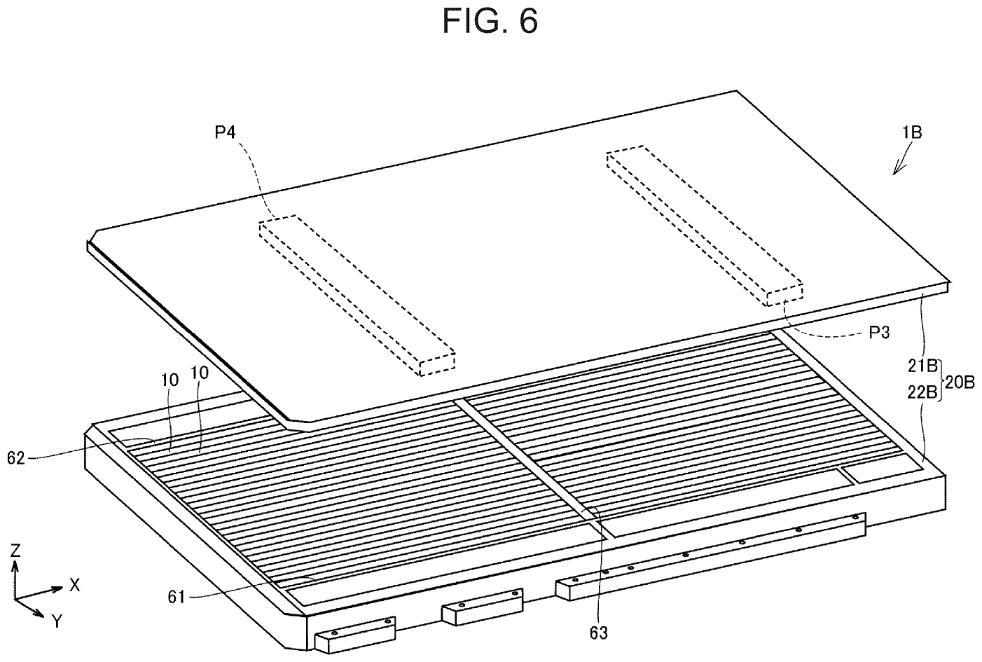

FIG. 6 is a perspective view that schematically shows an electric power storage device 1B according to a modification. In the electric power storage device 1B of the modification, a plurality of partition walls 61, 62, 63 is formed in the lower case 22B of the storage case 20B. The partition walls 61, 62 are formed to extend in the X direction, and the partition wall 63 is formed at the center portion in the X-direction of the lower case 22B so as to extend in the Y direction. The plurality of electric power storage units 10 has the same configuration as in the embodiment 1. The electric power storage units 10 are arranged and laminated in the Y direction between the partition wall 61 and the partition wall 62, whereby the electric power storage units 10 are housed in the housing case 20B. The electric power storage units 10 are also partitioned by the partition wall 63, whereby the electric power storage units 10 are arranged in two rows.

Each electric power storage unit 10 is bonded to the bottom surface of the lower case 22B with an adhesive member. Protruding portions P3, P4 extending in the Y direction (lamination direction) are formed in the upper case 22B. The protruding portions P3, P4 protrude toward the lower case 22B. The protruding portions P3, P4 abut against the electric power storage unit 10 at a substantially central portion in the longitudinal direction of the electric power storage unit 10.

In this modification, the protruding portions P3, P4 of the upper case 21B abut against the electric power storage unit 10, so that the electric power storage unit 10 receives a load on the adhesive member side (lower case 22B side), and is pressed down. This makes it possible to restrain the adhesion between the electric power storage unit 10 and the housing case 20B (lower case 22B) from being released.

In the above embodiment, some of the electric power storage units (for example, the electric power storage units at the end portion in the lamination direction) do not necessarily have to abut against the protruding portions formed on the upper case.

The embodiments disclosed herein should be considered to be illustrative and not restrictive in all respects. The scope of the present disclosure is not defined by the foregoing description, but defined by the claims, and is intended to include meanings equivalent to the claims and all alterations within the claims.

What is claimed is:

1. An electric power storage device comprising:
a plurality of electric power storage units; and
a housing case that includes a first case and a second case, and houses the electric power storage units in a space defined by the first case and the second case, wherein:
the electric power storage units are bonded to the first case,
the second case has a protruding portion protruding toward the first case, and
the protruding portion abuts against the electric power storage units.

2. The electric power storage device according to claim 1, wherein the electric power storage units are arranged in a lamination direction in the storage case, and the protruding portion extends in the lamination direction.

3. The electric power storage device according to claim 1, wherein:
each of the electric power storage units has a rectangular parallelepiped shape,
the electric power storage units are bonded to the first case at center portions in a longitudinal direction of the electric power storage units, and
the protruding portion abuts against the electric power storage units at the center portions in the longitudinal direction of the electric power storage units.

4. The electric power storage device according to claim 1, wherein each of the electric power storage units comprises:
a cell assembly in which a plurality of electric power storage cells arranged in a connection direction is electrically connected at a connection portion;
a cell case that houses the cell assembly; and
a reinforcing member that is disposed at the connection portion and reinforces the cell case, wherein the protruding portion abuts against the cell case at a position where the reinforcing member is disposed.

5. The electric power storage device according to claim 4, wherein the cell case is bonded to the first case at a position where the reinforcing member is disposed.
